(19) United States
(12) Patent Application Publication
(10) Pub. No.: US 2004/0042552 A1
(43) Pub. Date: Mar. 4, 2004

(54) Method and apparatus for determining motion vectors in dynamic images

(76) Inventors: Victor Pavlovich Dvorkovich, Moscow (RU); Alexander Victorovich Dvorkovich, Moscow (RU); Alexander Yurievich Sokolov, Moscow (RU)

Correspondence Address: Christopher S Daly, Daly Crowley & Mofford, Suite 101, 275 Turnpike Street, Canton, MA, 02021-2310, US

(21) Appl. No.: 10/333,275

(22) PCT Filed: Jul. 19, 2001
(86) PCT No.: PCT/GB01/03259

(30) Foreign Application Priority Data
Jul. 20, 2000 (RU) 2000/119205
Aug. 8, 2000 (GB) 0019508.1

(51) Int. Cl. H04N 7/12

(52) U.S. Cl. 375/240.16; 348/699

(57) ABSTRACT

In order to increase the speed of motion vector calculation characteristic pixels from a macroblock are selected and the control sum is calculated only from those pixels while the coordinates of those pixels are calculated using all pixels values in the macroblock. In one embodiment the rows of pixels are re-odered in ascending value and serveral equidistant pixels selected. The columns of selected pixels are then re-ordered in increasing value order and several equidistant pixels selected to provide the characteristic pixels. In a second embodiment pixels are selectred in a drecreasing order of deviation from the mean value of a row. The selected pixels are arranged in columns and further selected on the basis of decreasing order of deviation from the absolute value of the column average. In a third embodiment the macroblock is divided into sub-blocks and a single characteristic selected having the maximum or minimum value for that sub-block. Selection of maximum or minimum alternates from block to block.

This invention relates to the determination of motion vectors in the coding and decoding of dynamic images.

The transmission of digital images relies on compression of the digitised picture information to reduce the amount of data to be transmitted. The degree of compression required will depend on the width of the transmission channel. A number of standards such as MPEG-2 exist which define digital video compression parameters. However, a great deal of flexibility remains as to the algorithms used to encode images. Encoding images which do not differ from frame to frame is straightforward. Once the image has been encoded, all that is required is a signal indicating that an image has not changed in the next frame. This signal may apply to the whole frame or to one or more portions of the frame known as macroblocks. However, where the image contains movement, coding becomes more difficult. Rather than recoding the whole image, motion vectors are used to estimate to where the content of a given macroblock has moved to enable the image to be reconstructed without having to retransmit all the video data.

The calculation of motion vectors is very complex involving a very large number of calculations, requiring considerable processing power. Several techniques have been proposed for reducing the amount of calculations required to determine the motion vectors of macroblocks or picture elements (pixels) in dynamic images. The choice of motion vectors is referred to a search and involves searching a library of motion vectors before assigning the most appropriate vector to a given picture element or macroblock.

The most simple and accurate of the known techniques calculates motion vectors of macroblocks based on a full search algorithm. This is disclosed in “Techniques and Standards for Image, Video and Audio Coding” by K R Rao, J J Hwang, 1996, Prentice-Hall PTR, ISBN 0-13-309907-5. In this method, to search the motion vector [symbol] =(Vₓ, V_{y}) the norm of the difference between two luminance signals of two macroblocks in the current and reference frames with the shift on the motion vector is considered; thus:

SAD=Σ|F(x,y,t)−F(x−V_{x,}y−V_{y},t−Δt)| (1)

x,y=1, 16

Where F is the luminance value for spatial coordinates (x, y) of the frame having temporal index t, with the summation being carried out for all pixels in the macroblock. The value of \overline{v} giving the smallest value of SAD is the sought vector as it indicates the motion vector which produces the smallest difference between current and reference frames. Motion vectors are searched by means of a full search through all motion vectors in some restricted area min<V_{x,}V_{y}<max. Assuming that the size of this area is equal to ±N pixels over coordinates x and y one finds that the number of operations necessary for motion vector determination for one macroblock is in the order of 3.256 (2N+1)². This is 3.(2N+1)² operations per each pixel which already for N=15 (motion vectors are within the area ±15 pixels) becomes a significant number greater than 10³ operations/pel.

This method is used as the standard method for quality estimation of other motion vector search methods. Whilst this method is accurate, it has the disadvantage of involving a large amount of computations and being relatively low in performance.

Russian patent RU-A-2137194 filed Jul. 15, 1998 of A V Dvorkovich, V P Dvorkovich, Yu B Zubarev and A Yu Sokolov discloses a method of motion vector estimation of elements in dynamic images which includes the transformation of the sequence of images into the digital form, memorizing the pixel levels of the current and reference frames, division of the current frame into a set of macroblocks and the search of motion vectors for every macroblock with respect to the reference frame by means of minimizing the macroblock control sum inside the set of motion vectors considered. The control sum is equal to the sum of the norm of the difference of pixel levels in the current and reference frames, while all pixels of the macroblock are divided into the areas. In each area only one (which will be referred to later as the “selected” or “characteristic”) pixel is selected. The control sum is calculated with the selected pixels only. The selected pixels are chosen in each area such that their levels in the neighboring areas have the maximum deviation from one other.

Furthermore, in this prior art method of motion vector analysis, for every value of probe motion vector, the calculation of the control sum with the selected pixels mentioned above is carried out in decreasing order of the absolute deviation of the pixel level from the average value among all selected pixels. The calculation of the control sum is terminated when its value becomes larger than the minimum value of the control sum found among motion vectors already considered.

The method disclosed in RU-A-2137194 is limited as every macroblock is divided into several strictly fixed areas in which, according to the given algorithm, only one pixel is selected, while the structure of the pixel levels in other areas is not taken into account during the selection. This is limiting and is only one possible method of selecting characteristic pixels in macroblocks. Another method of selecting characteristic pixels is disclosed in RU-A-2137194 and is based on statistical re-ordering of all pixels in a macroblock. It is also restrictive and is again only one possible method of selecting characteristic pixels. Furthermore, the use of characteristic pixels to search for motion vectors is performed in RU-A-2137194 only for original frame resolution, which reduces the benefit in terms of the reduction of computations.

According to the invention there is provided a method for determining motion vectors representing movement between frames in a sequence of video images, comprising: storing the pixel vales of a current frame and reference frame; dividing the current frame into a set of macroblocks; for each current frame macroblock, selecting fro the pixels of the macroblock a plurality of pixels characteristic of the relief of all the pixels of the macroblock; and searching for a motion vector for the macroblock with respect to the reference frame by minimizing a macroblock control sum for a set of motion vectors considered, the control sum being equal to the sum of the norm of the difference between the selected characteristic pixels in the current frame macroblock and the reference frame, wherein the coordinates of the selected characteristic pixels are calculated using all pixel values in the macroblock.

The invention also provides apparatus for determining motion vectors representing movement between frames in an sequence of video images, comprising: a storage means for storing pixel values of a current frame and a reference frame; means for dividing the current frame into a set of macroblocks; selection means for selecting, for each current frame macroblock, from the pixels of the macroblock a plurality of pixels characteristic of the relief of all the pixels of the macroblock; search means for search for a motion vector for the macroblock with respect to the reference frame by minimizing a macroblock control sum for a set of motion vectors considered, the control sum being equal to the sum of the norm of the difference between selected characteristic pixels; and means for calculating the coordinates of selected characteristic pixels using all pixel value in the macroblock.

The invention also resides in a computer program which, when loaded onto a computer causes the computer to perform the steps set out above.

Embodiments of the invention have the advantage of reducing the computational complexity of motion vector searching whilst allowing a more general possible selection of characteristic pixels, which characterize the shape or skeleton of macroblock values.

Preferably, down-sampling the pixels of the current and reference frames prior to storage of the current and reference frame values, determining one or more best motion vectors for each macroblock, each macroblock having a reduced number of pixels, the one or more best motion vectors being determined with respect to the down sampled reference frame by minimising the control sum using the characteristic pixels for the macroblock, increasing the value of the one or more (K) motion vectors by the ratio of the original resolution prior to down sampling to the resolution after down sampling; and in the region of the one or more motion vectors obtained, searching the macroblock motion vector by minimising the control sum using the pixels of the macroblock at original resolution, prior to down sampling.

The vales of one or several (K) motion vectors found are increased in the factor of the ratio of the original resolution after the down-sampling, after that in the vicinity of one or several vectors obtained the motion vector of the macroblock is searched with the integral or half pixel accuracy by means of minimization of control sum with the use of pixels of macroblock of original resolution.

This technique is beneficial because we appreciated that performing the motion analysis on small resolution frames (e.g. using our characteristic pixel method) provides sufficient information about motion vectors for the original frame resolution. One can simply think that the motion vectors searched in the original frame must be close to the double values of motion vectors corresponding to small resolution frames. In other words, with high probability the motion vector satisfies the following inequality:

2Vₓ₀−Δ≦Vₓ≦2Vₓ₀+Δ, 2V_{y0}+Δ≦V_{y}+≦2V_{y0}+Δ, where

(Vₓ₀,V_{y0}) is the best vector found at small resolution and Δ is a small number. Typically, it is enough to set Δ=1. However, the word “high probability” does not mean “always”. The obtained vector (Vₓ₀,V_{y0}) can correspond to wrong vector because high frequencies were lost in macroblock after down sampling. The idea goes further to use for analysis several best vectors (V⁽ⁿ⁾ₓ₀,V⁽ⁿ⁾_{y0}) found at low resolution (n is the number of the n-th best vector), and perform the search of the final vector in the set of areas:

2V⁽ⁿ⁾ₓ₀−Δ≦Vₓ≦2V⁽ⁿ⁾ₓ₀+Δ, 2V⁽ⁿ⁾_{y0}−Δ≦V_{y}≦2V⁽ⁿ⁾_{y0}+Δ,

n=1, 2, 3, . . . K

The word “vicinity” therefore includes within its scope that Δ is small.

Preferably, the selection of characteristic pixels comprises re-ordering pixels in each row of a macroblock in order of value; selecting a number of pixels at points along the row of re-ordered values; re-ordering columns of selected pixels in order of value; selecting the characteristic pixel for the macroblock from points spaced along the re-ordered columns, and storing the coordinates in the original macroblock of the selected characteristic pixels.

Preferably, the selection of characteristic pixels comprises selecting a number of pixels in the order of decreasing deviation of the absolute values of the pixels from the average value of pixels in the row; arranging the selected pixels into columns and selecting a number of pixels from the columns in the order of decreasing deviation of the absolute values of the pixels from the average value in the column; and storing the coordinates in the original macroblock of every selected pixel.

Preferably, the selection of characteristic pixels comprises dividing macroblocks into a plurality of sub-blocks; selecting the maximum or minimum value pixel from each sub-block such that in the sub-blocks adjacent any given sub-block for which one of the maximum or minimum is selected, the other of the maximum or minimum is selected as the characteristic pixel; and storing the coordinates in the original macroblock of the selected pixels of each sub-block.

Preferably, the consideration of each possible value of motion vector for each macroblock in the minimum control sum determination using the characteristic pixels is carried out in decreasing order of the absolute deviation of the value of the signal at each characteristic pixel from the man value for the set of all characteristic pixels in the macroblock, and wherein the calculation of the minimum sum is terminated if its value exceeds the Kth minimum value of the control sum already determined from motion vectors considered.

Preferred embodiments of the invention have a reduced computational complexity which in turn allows the reduction in the complexity of motion vector calculation apparatus at the hardware level. The performance of coding devices may be increased and consequently, analysis of moving elements in dynamic images may be carried out within larger limits. The volume of compressed information may be reduced and the quality of reproduction of fast moving elements may be increased.

Embodiments of the invention may find application in a wide range of devices for which video compression is required, including, but not limited to, videophones, videoconferencing, standard and high definition digital televisions, digital cameras and delivery of video images over narrow band channels such as the Internet or mobile telephones. In each of these applications the embodiments of the invention reduce the number of calculations required during the motion vector search and increase the search area for motion vector determination resulting in an enhanced reproduction, particularly for fast moving elements.

Embodiments of the invention will mow be described, by way of example only, and with reference to the accompanying drawings, in which:

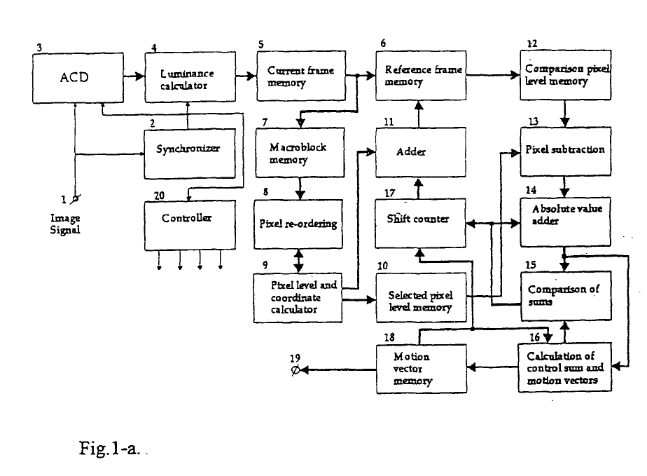

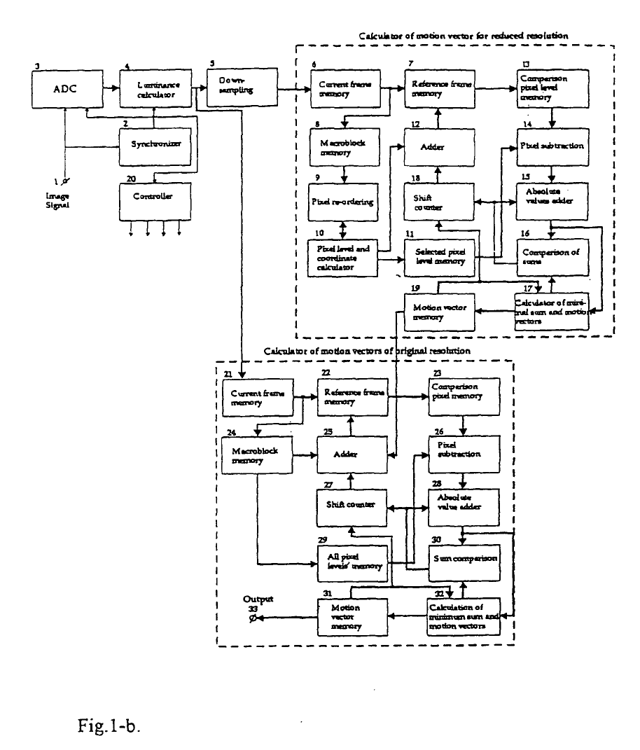

FIG. 1-a is a block diagram illustrating a first embodiment of the invention;

FIG. 1-b is a block diagram showing in more detail, a second embodiment of the invention;

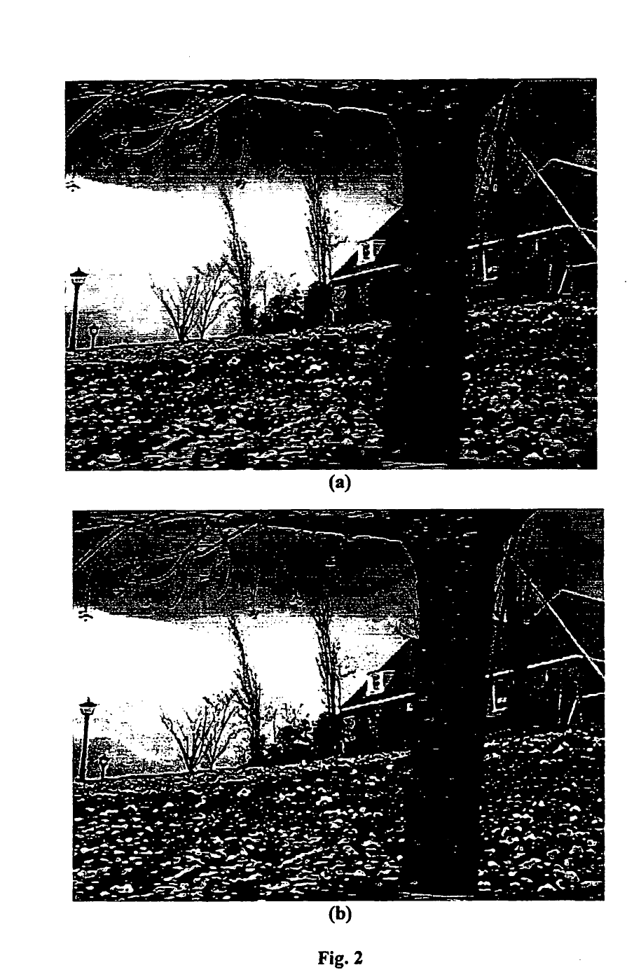

FIG. 2 shows current (a) and reference (b) frames from a test sequence entitled “Flower Garden”;

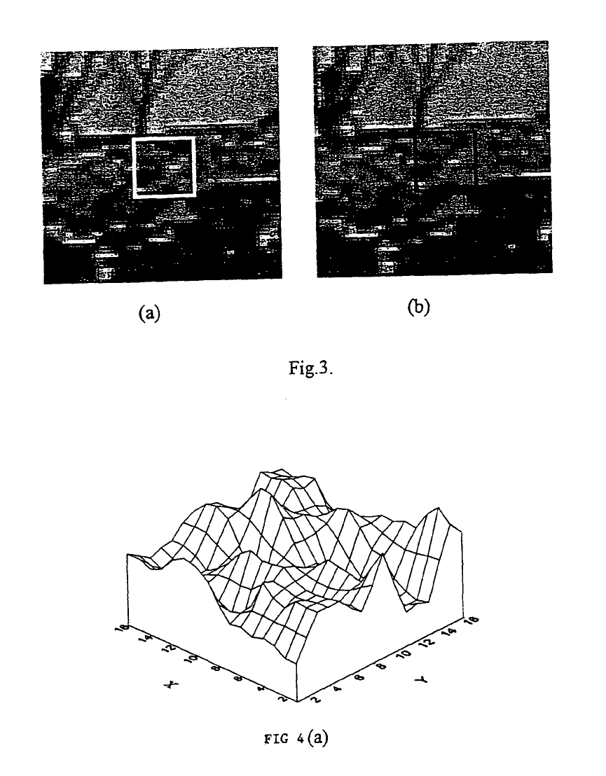

FIG. 3 shows an enhanced view of one macroblock from the “Flower Garden” sequence of FIG. 2;

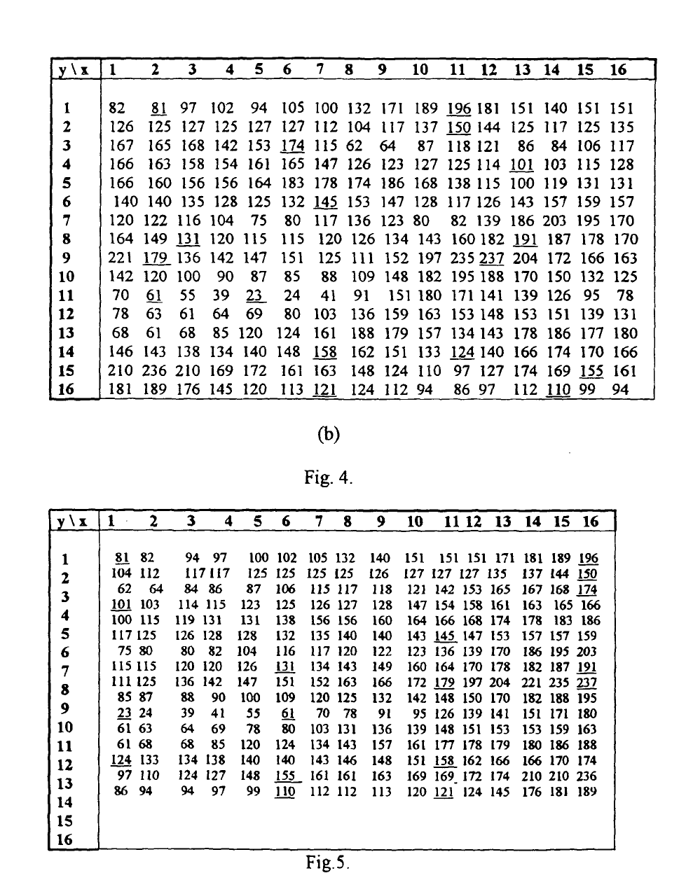

FIG. 4-a shows the relief of values of luminance of the selected macroblock of FIG. 3 and FIG. 4-b shows those values in tabular form;

FIG. 5 shows the values of pixels in the selected macroblock written in value increasing order along rows and according to a first method of selection of characteristic pixels;

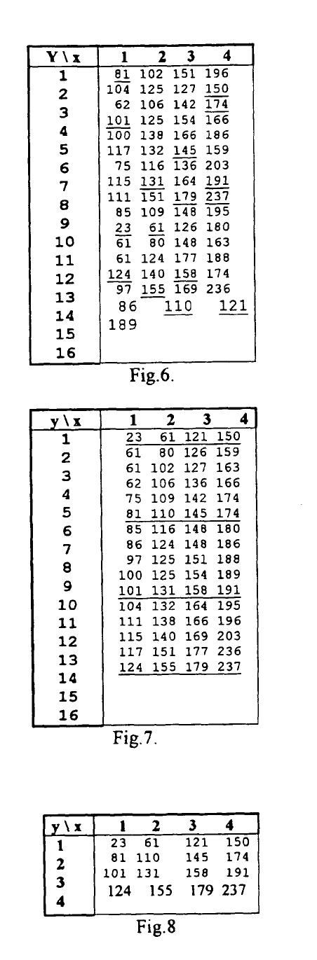

FIG. 6 shows the levels of pixels of the macroblock in the selected columns;

FIG. 7 shows the levels of pixels of the macroblock in value increasing order along columns;

FIG. 8 shows the level of pixels of the macroblock selected as characteristic;

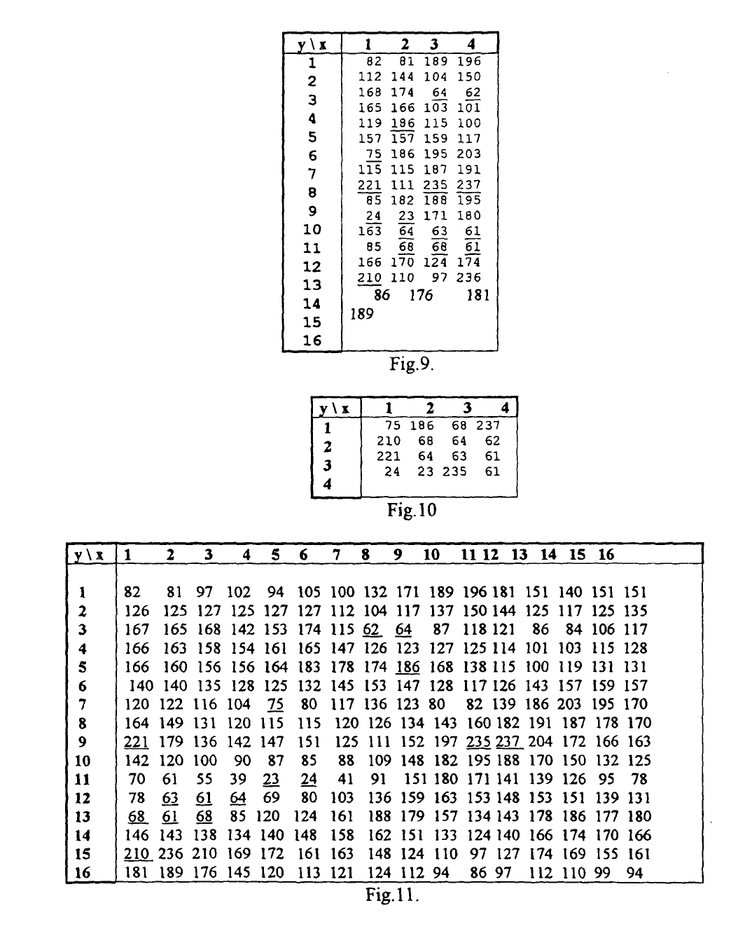

FIG. 9 shows the values of pixels of the selected macroblock selected as rows and according to a second method of selection of characteristic pixel selection;

FIG. 10 shows the values of selected characteristic pixels in the selected block according to the method of FIG. 9;

FIG. 11 shows the location of characteristic pixels in the macroblock using the FIG. 9 method;

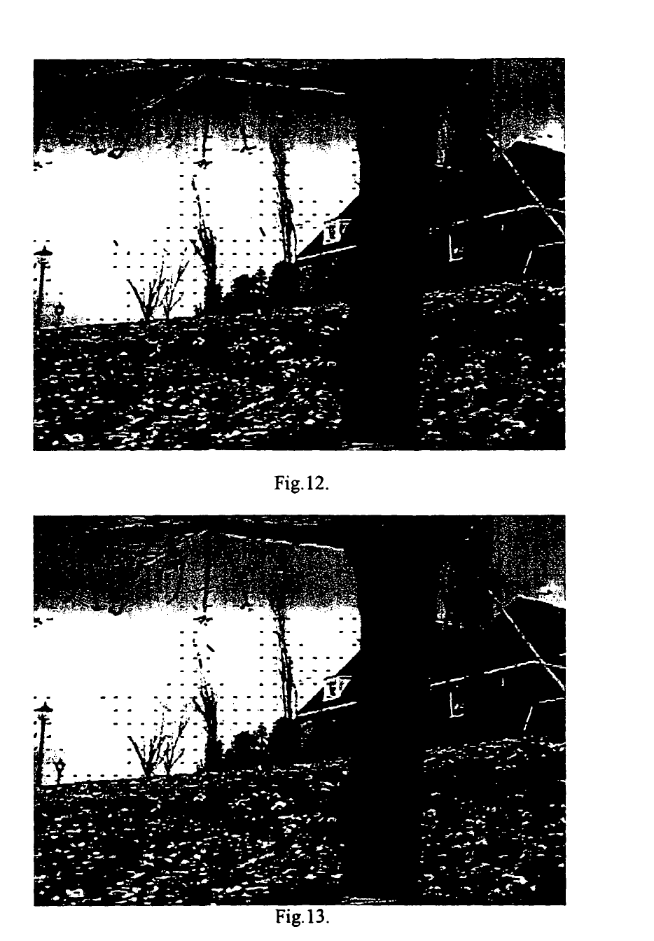

FIG. 12 shows the motion vectors calculated using the method of the first embodiment of the invention;

FIG. 13 shows the motion vector calculated using the method of the second embodiment of the invention;

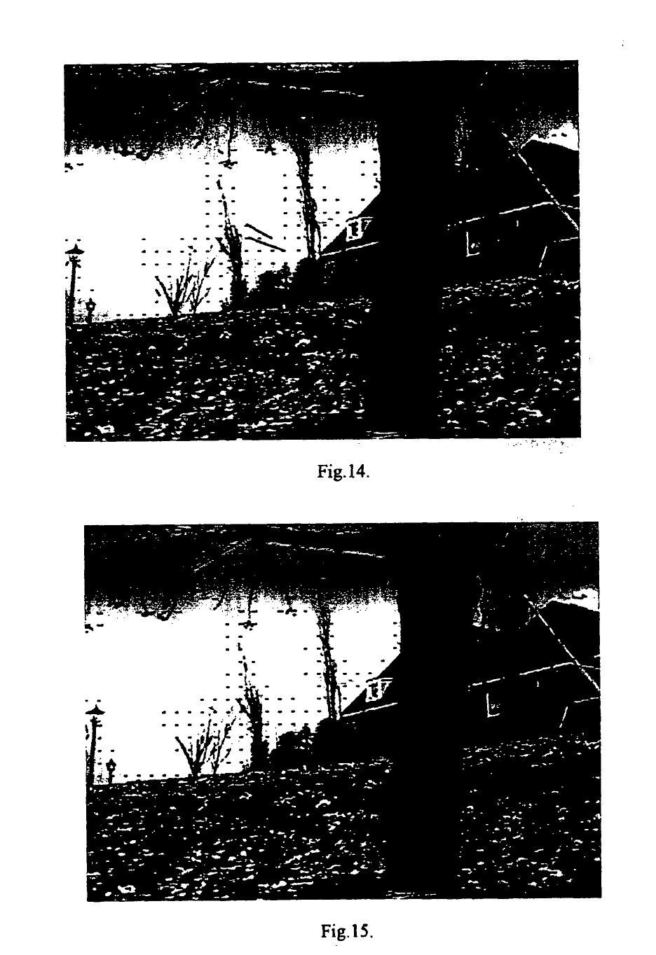

FIG. 14 shows the motion vectors calculated using the method of a third embodiment of the invention;

FIG. 15 shows the motion vectors calculated using the prior art full search algorithm;

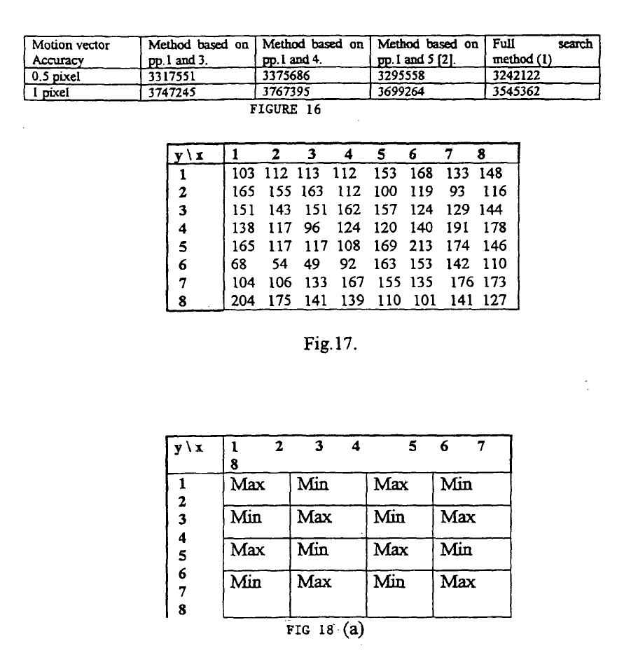

FIG. 16 is a table showing the size of MPEG-2 code in bytes for the “Flower Garden” sequence having 97 frames coded using the circuit of FIG. 1 and each of the three methods embodying the invention as well as the prior art full search method;

FIG. 17 shows the values of pixels of the selected macroblock after down-sampling using the circuit of FIG. 2 and the third method embodying the invention;

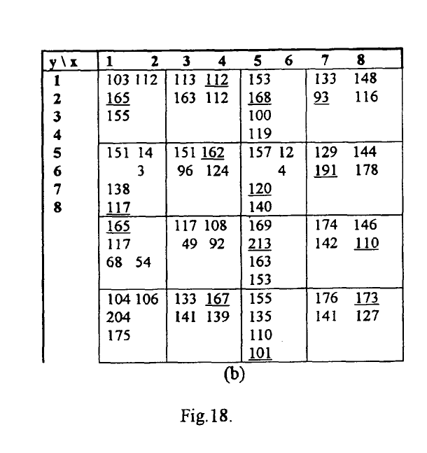

FIG. 18a) and b) shows the division of a macroblock into regions and the location of selected pixels in those regions using the method of FIG. 17.

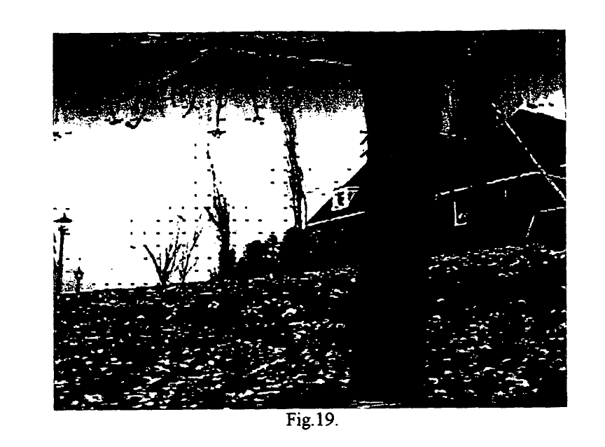

FIG. 19 shows the motion vectors calculated using the method of FIG. 17; and

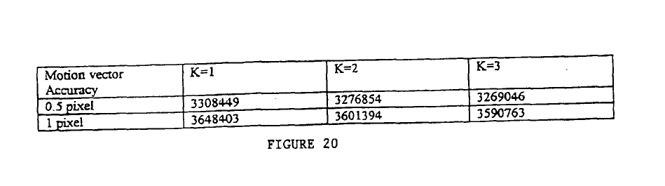

FIG. 20 is a table similar to FIG. 20 without filtering in the circuit.

FIG. 1(a) shows a first embodiment of an apparatus for conducting a motion vector search. A synchronisation block 2 is connected in parallel to a source of images 1. The image source is also connected to an analogue-to-digital convertor 3 the output of which forms an input to a luminance signal calculator 4. The luminance calculator 4 also receives an input from the synchronisation block 2. The output of the luminance calculator 4 forms an input to a current frame memory 5 the output of which forms the input to a reference frame memory 6 and a macroblock memory 7. The current frame memory 5 stores the pixels of the current frame, the reference frame memory 6 stores the pixels of the reference frame and the macroblock memory 7 stores the current macroblock 7. The output of the macroblock memory 7 forms the input to a pixel re-ordering block 8 which re-orders the pixels of the current macroblock. The output of the pixel re-ordering block 8 is connected to a calculator 9 which can determine the coordinates and values of characteristic pixels of the macroblock. The calculator 9 has a first output to a memory 10 which stores the levels or values of selected or characteristic pixels and a second output to an adder 11 the output of which is connected to the inputs of the controller of the reference frame memory 6. The reference frame memory 6 outputs data to a comparison pixel level memory 12. The outputs of memory 12 are connected to the first inputs of a pixel subtraction block which subtracts the levels of characteristic pixels in the current frame and pixels in the reference frame. The second inputs of the subtraction block 13 are provided by the output of the selected or characteristic level memory 10. The outputs of the pixel subtraction unit are connected to the inputs of an absolute value adder 14 which provides the input of a comparator 15 which compares the control sums. The output of the adder 14 also forms the input to a calculator 16 which calculates the minimum sum for the current motion vector. The comparator 15 takes its second input from the output of the minimum sum calculator 16. The output of the comparator 15 forms an input to the absolute value adder 14 and an input to a shift counter 17 which itself provides a second input to the adder 11. The minimum sum calculator 16 also has an output to motion vector memory 18 to provide motion vectors to an output 19. The motion vector memory 18 provides a second output in parallel to the calculator 16 and to the shift counter 17.

The synchroniser 2 has an output to both the analog-to-digital convertor 3 and the luminance calculator 4. The device also has an output to a controller 20 to synchronise the various function blocks 5-18 described.

Turning now to FIG. 1(b) there is shown an expanded version of the embodiment of FIG. 1(a). The device illustrated has three main parts, an input, a calculator 40 for calculating reduced resolution motion vectors and a calculator 50 for calculation of motion vectors at original resolution. The reduced resolution motion vector calculator 40 has a similar functionality to blocks 5-18 of FIG. 1(a) and operates on a down-sampled version of the digitised input signal. The original resolution motion vector calculator 50 operates on a digitised version of the signal taken prior to down sampling.

Thus, in FIG. 2, an image signal source 101 is input in parallel to a synchroniser 102 and in series to an analog-to-digital convertor 103, a luminance calculator 104 and a down-sampler 105. The luminance calculator 104 determines the digital values of the luminance signal for each pixel and the down sampler 105 reduces the number of samples according to one of a number of well known sample reduction methods. The down-sampled pixels are passed to memories 106 and 107 which store, respectively, the current and reference frames. The output of the current frame memory, as well as providing the input to the reference frame memory 107 also provides the input to macroblock memory 108 which stores the current macroblock under consideration for motion vector determination. The output of the macroblock memory provides the input to a re-ordering block which re-orders the pixels of the current macroblock. The pixel re-ordering block outputs pixel data, and can also receive input data, from a pixel level and coordinate calculator 110. The calculator 110 determines the coordinates and levels or values of the characteristic or selected pixels of the macroblock under consideration. The pixel level and coordinate calculator 110 has a first output to a memory 110 which stores the values of selected or characteristic pixels. The calculator 110 has a second output to an adder 112 the output of which forms an input to the controller of the reference frame memory 107. The reference frame memory 107 provides an input to a memory 13 which stores the values of comparison pixels and has an output which provides the input to a subtractor 114 which subtracts the levels of characteristic pixels in the current frame and characteristic pixels in the reference frame. The second input to the pixel subtractor 114 is provided from the memory 111 which stores the values of the selected pixels. The output of the pixel subtractor 114 provides an input to an absolute value adder 115 the output of which is provided both to a comparator 116 and a minimum sum calculator 117. The comparator 116 compares the control sums in order for the smallest control sum to be determined and the calculator 117 calculates the minimum sum for current motion vectors. The calculator 117 has an input to the comparator 116. The comparator 16 has an output to the absolute values adder 115 and to a shift counter 118. The output of the shift counter 118 provides the second input to adder 112 the first input of which is provided by the pixel level and coordinate calculator. The minimum sum calculator 117 provides an output to a motion vector memory 119. The motion vector memory provides outputs to the shift counter 118 and the minimum sum calculator 117. The device from the current frame memory 116 to the motion vector memory 119 forms a reduced resolution motion vector calculator 40. It will be seen that this calculator operates on a down-sampled input signal.

As in the embodiment of FIG. 1(a), the synchroniser 102 provides a synchronising input to the analogue-to-digital convertor 103 and the luminance calculator 104 as well as to a controller device 120 which controls the reduced resolution motion vector calculator. The controller 120 also controls the various blocks of the original resolution motion vector calculator 50. The original motion vector calculator 50 includes a current frame memory 121 which receives the digitised luminance signal in a non-down-sampled form. The current frame memory is connected to a reference frame memory 122 which outputs to a comparison pixel memory 123. As well as providing the input to the reference frame memory 122, the output of the current frame memory 121 also provides the input to a macroblock memory 124. These memories essentially perform the same function as the corresponding memories 106/108 in the reduced motion vector calculator 40. The macroblock memory 124, which stores the macroblock under consideration has an output to an adder 125 another of whose inputs is provided the output of motion vector memory 119. The third input to the adder is provided from a shift counter 127. The output of the macroblock memory 124 also provides an input to a memory 129 which holds the value of all pixel values in the macroblock.

The comparison memory 123 provides an output to a subtractor 126 whose second input is provided from the memory 129 holding the value of all pixels in the macroblock. The output of the subtractor 126 forms the input to an adder 128 which adds absolute values and whose output provides an input to a sum comparator 130 and a calculator 132 which calculates the minimum sum of the motion vectors. The calculator 132 has an output which provides an input to the sum comparator 130 and to a motion vector 131. The output of the sum comparator 130 provides an input both to the absolute value adder and to the shift counter 127. The motion vector memory also provides an input to the shift counter and an input to the minimum sum calculator 132. The motion vector memory also provides an output 133 in the form of motion vectors for the area under consideration.

The manner in which the embodiments of the invention function will now be described with reference to FIG. 2. In FIG. 2, current (FIG. 2a) and reference (FIG. 2b) frames from the MPEG “flower garden” test sequence are illustrated. The method is described in relation to a single macroblock from the dynamic image sequence. FIG. 3 shows an enlarged part of the current and reference frames with the selected macroblock marked by a white border in FIG. 3a. The corresponding position in the reference frame is marked in FIG. 3b as a dark frame although, taking into account motion between the current and reference frames, the video content of the macroblock area in FIG. 3 may not be the same as that of the FIG. 3a macroblock. The macroblock has a size of 16×16 pixels and the search window, that is the area used for the motion vector search is 64×64 pixels.

In the full standard motion search method referred to earlier in the Rao and Hwang publication entitled “Techniques and Standards for Image, Video and Audio Coding”, as applied to a 16×16 macroblock, a computational power of 3×49²=7203 operations is required for every pixel of the macroblock. FIG. 4a shows the value of the pixels in a graphical form and FIG. 4b shows those pixel values in a numerical tabular form.

In essence, the present invention selects a number of pixels which characterise the shape or relief of the macroblock. The control sum is then calculated only using those selected or characteristic pixels whilst the coordinates of the selected pixels in the macroblock are calculated using the values of all pixels in the macroblock.

Thus, several characteristic pixels are selected in the macroblock which characterise the relief, or the skeleton, of the macroblock.

Referring to FIG. 5, there is shown the value of pixels for a 16×16 macroblock. These pixels are stored in the macroblock memory 7 in FIG. 1a (108 in FIG. 1b). The pixels are then re-ordered on a row by row basis such that they are presented in an increasing order. The re-ordered pixels are shown in FIG. 5. For example, it will be seen in FIG. 5 that in row 1, the pixel at position 1, 1 is the smallest whereas the pixel at 1, 16 has the highest value for that row. This re-ordering takes place in pixel re-ordering unit 8 in FIG. 1a or 109 in FIG. 1b.

Once the pixels have been re-ordered the pixels of columns 1, 6, 11 and 16 are selected. These are shown in FIG. 6. It will be seen that, in FIG. 5, characteristic pixels are shown underlined and that the columns selected are those which include characteristic pixels.

Turning now to FIG. 7, the pixels in the selected columns are re-ordered and arranged in increasing order. Thus, in the first column the pixel at position 1, 1 has a value of 23, being the lowest of that column and the pixel at 1, 16 has a value of 124 being the highest in that column.

Turning to FIG. 8, the final selection of the characteristic pixels in now made. In the present method, the pixels of rows 1, 6, 11 and 16 are selected as being characteristic. These pixels, it can be seen, are the highest and lowest of each column together with two mid-point values. Other characteristics could be selected. The characteristic pixels are shown underlined in each of FIGS. 4-8 but it is to be understood that the selection of characteristic pixels does not occur until this stage. As the characteristic pixels are selected, their coordinate values in the original macroblock are stored and held in the selected pixel level memory 10 of FIG. 1a (111 in FIG. 1b).

To search for motion vector \overline{v}=(V_{x,}V_{y}), the sum of the norms of the differences of signals at the selected pixels in the current macroblock and the corresponding pixels in the reference frame with the shift on motion vector is considered, thus:

SAD1=Σ|F(x,y,t)−F(x−Vₓ,y−V_{y}t−Δt)| (2)

(x,y)−co-ordinates of characteristic pixels in the macroblock

The characteristic pixels may be selected in other ways. In one alternative embodiment, from the original pixel macroblock show in FIG. 4, for each row, only a few first pixels with the maximum value of absolute deviation of pixel level from the average level of pixels in the row are selected as shown in FIG. 9. Thus, in FIG. 9, it can be seen that in the first row the pixels from x={1, 2, 10 and 11} are selected. In the second row, the pixels from x={7, 8, 11, 12} are selected. In the third row the pixels from x={9, 10, 3, 6} are selected and so on. At the next stage, shown in FIG. 10 for each column formed by the selected pixels, only several first pixels having the maximum value of absolute deviation of pixel level from the average level of pixels in the column are selected. Thus, in FIG. 10, the first column selects pixels y={7, 9, 11, 15} from the pixels of FIG. 9, the second column selects pixels y={5, 13, 12, 11} and so on. The pixels selected in this way are used as the characteristic pixels, their locations in the original macroblock are shown in FIG. 11 by underlining.

To search the motion vector V=(V_{x,}V_{y}) using the method if equation (2) above, the sum of norms of differences of signals at selected pixels in the current macroblock and the corresponding pixels in the reference frame with the shift on motion vector is considered.

Using the two methods described for the selection of characteristic pixels, it is necessary to carry out about (16.(16+1).16/2+\sqrt{M}.(16+1).16/2)/256≈10 operations for every pixel of macroblock, where M is the number of characteristic pixels (in this particular case M=16). To search for a motion vector using the expression of equation 2 it is necessary to carry out about

$$\frac{M}{256} 3 \cdot {( 2 N + 1 )}^{2} operations .$$

For a search window N>10 the number of operations necessary for the selection of characteristic pixels is negligibly small in comparison with the number of operations necessary for calculation of the control sum (20) and search for the best vector. Therefore according to methods described, the motion vector search is accelerated approximately 256/M=16 times, where M=16.

The efficiency of the methods described is illustrated by FIGS. 12-16. FIGS. 12-14 show the motion vectors calculated with the use of the methods for two frames of the MPEG-2 “Flower Garden” sequence. FIG. 12 is based on the first method of characteristic pixel selection as shown in FIGS. 5 to 8 and FIG. 13 is based on the second method described as shown in FIGS. 9 and 10. FIG. 14 is based on a third method in which each macroblock is divided into several regions with one characteristic pixel only being selected from each region. The selected pixel in a given sub-block is either the maximum or minimum with the opposite minimum or maximum being selected in neighboring blocks. The pixel value and its coordinates are stored in memory. FIG. 15 shows the motion vectors calculated with the use of standard algorithm based on the use of all pixels of macroblock as defined in equation (1). As can be seen from FIGS. 12 to 15 the motion vectors for all methods are almost the same and correspond to correct physical motion. In order to provide a quantitative estimation of the proposed methods consider the results of coding of the test sequence within the framework of MPEG-2 standard as defined in ISO/IEC 13818-2. Information Technology—Generic Coding of Moving Pictures and Associated Audio Information. Part 2: Video./Ed.1 JTS I/SC 29, 1994. Because MPEG-2 allows use of motion vectors with half pixel accuracy it is necessary to consider two encoding cases: (i) without specification of the accuracy of the motion vectors obtained according to the embodiments described and (ii) with the specification within +/−0.5 pixels and the use of linear interpolation between pixels for sub-pixel values.

In the case of specification of motion vectors within +/−0.5 pixels the control sum defined in equation (1) with all 256 pixels will be used. The specification of the motion vectors will require about 3.9=27 additional operations per pixel. FIG. 16 is a table showing the results of encoding by the various methods described. In FIG. 16, the reference to the first embodiment refers to that described with reference to FIGS. 5 to 8, the reference to the second embodiment refers to that described with reference to FIGS. 9 and 10 and the reference to the third embodiment refers to the method of sub-dividing each macroblock and assigning, alternatively, the minimum or maximum pixel in the sub-block as the characteristic followed by storing the values selected and their coordinates within the macroblock. The reference to the full search refers to the summation expressed in equation (1). The table shows the size of MPEG-2 code in bytes for the “Flower Garden” sequence which contains 97 frames with a resolution of 640×480 pixels. Analysis of FIG. 16 shows that the proposed methods provide a significant acceleration of the motion vector search (16 fold when M=16). At M+=16 the compression ratio is decreased by no more than 1-3% for half pixel accuracy and 4-10% for whole pixel accuracy. The best result corresponds to the method of the third embodiment, the worst to the method based on the second embodiment.

Referring back to FIG. 1b, the circuit shown performs a down-sampling of the image samples prior to reduced resolution motion vector calculation. This method will now be described in detail.

In the following description a macroblock from one macroblock from the dynamic image shown in FIG. 2 is considered by way of example, with the use, following the results shown in FIG. 16, of the best algorithm for selection of the characteristic pixels based on the third method described. In distinction from the methods described previously, the current and reference frames are down-sampled before the selection of characteristic pixels of every macroblock.

Down-sampling is performed by reducing either or both the horizontal and vertical resolution by filtering. Various types of filtering may be used and, alternatively, only one of the horizontal and vertical resolutions may be down-sampled. Consider the case when the down-sampling is performed with the reduction of horizontal and vertical spatial resolution by a factor of two by averaging neighboring pixels. Thus:

$$\begin{matrix}{F}^{( d )} ( x , y ) = \frac{1}{4} F ( 2 x , 2 y ) + F ( 2 x + 1 , 2 y ) + \\ F ( 2 x , 2 y , + 1 ) + F ( 2 x + 1 , 2 y + 1 ) )\end{matrix} \qquad ( 3 )$$

Here F^{(d)}(x,y) is the pixel value after down-sampling. According to equation (3) the pixels of the macroblock shown in FIGS. 3 and 4 after down-sampling will have the values shown in FIG. 17. Filtering reduces noise and motion search gives a slightly better result. Eq.(3) can be referred to as “filter” because it corresponds to a filtering in the frequency domain. However, the filter could be other types, though the one shown in Eq.(3) is preferred.

The down-sampled macroblock of size 8×8 pixels is divided into several regions. In each region only one maximum or minimum value is selected alternatively as a characteristic pixel. Thus, in the case under consideration, where the number of characteristic pixels is 16, FIG. 18 shows the macroblock divided into 16 sub-blocks with characteristic pixels selected according to the maximum and minimum regime of FIG. 18a. The selected pixels are underlined.

To search the motion vector \overline{v}=(Vₓ,V_{y}) the sum of norms of differences between signals at selected pixels in the macroblock and the corresponding pixels in the current and reference down-sampled frames with the shift on motion vector is considered. Thus:

SAD1d=Σ|F^{(d)} (x,y,t)−F^{(d)}(x−Vₓ,y−V_{y},t−Δt)| (4)

Coordinates of characteristic pixels pixels of macroblock

In the process of minimization of equation (4) in the search window of the size of ±N/2 pixels, K vectors V1d, V2d, V3d, . . . , VKd giving the smallest values of SAD1d are selected:

Min=SAD1d(V1d)≦SAD1d(V2d)≦SAD1d(V3d) (5)

After finding the best vectors V1d, V2d, V3d, . . . , VKd corresponding to the down-sampled current and reference frames the values of motion vectors are increased in the ratio of resolutions of original and down-sampled frames, in the case considered in by a factor of 2. After that, in a small area (i.e +/−1 pixel) around the values obtained for the vectors, in this case around vectors 2xV1d, 2xV2d, 2xV3d, . . . ,2xVKd, the minimization of the control sum according equation (1) is carried out and the best vector is determined which provides the minimum of value of equation (1). This vector is taken as the final motion vector of the macroblock in the case of whole pixel motion vector accuracy.

Where half pixel is used, that is motion vector accuracy as it is used in the MPEG-2 standard, the last vector found is specified with the use of equation (1) in the vicinity of +/−0.5 pixel around its value or at once around small vicinities (i.e. +/−1 pixel) around vectors 2xV1d, 2xV2d, 2xV3d, . . . , 2xVKd with half pixel accuracy.

To search for motion vectors using the first embodiment described above, the number of operations per pixel of down-sampled frame where the search for motion vectors is performed on the down-sampled frame, is about

$$3 \frac{16}{64} {( 2 \cdot \frac{N}{Z} + 1 )}^{2} ,$$

where Z equals to the ratio of original and down-sampled resolutions.

In the example given, Z=2, or

$$\frac{1}{4} 3 \frac{16}{64} {( 2 \cdot \frac{N}{Z} + 1 )}^{2}$$

per pixel in the frame of original resolution. The specifying of the motion vectors in the vicinity of each motion vector found takes a small amount of operations of the order of _{3K(2.1+1)}²_{per pixel} in the frame of original resolution, where K is the number of best vectors obtained, and does not depend on the size of search window N. For small K≦3 and N>10 the last number can be ignored. In this case the acceleration factor in comparison with standard full search algorithm becomes

$$\frac{1}{4} 3 \frac{16}{64} ( 2 \cdot \frac{N}{Z} + 1 ) \frac{2}{3} \frac{16}{64} {( 2 \cdot \frac{N}{Z} + 1 )}^{2} \approx 16 {Z}^{2} = 64 \qquad when Z = 2.$$

In addition, the acceleration of motion vector search may be further increased by choosing a specific order of calculation of the control sums SAD1 or SAD1d.

Thus the mean value of characteristic pixels of macroblock is calculated:

$$\begin{matrix}Fcp = \frac{1}{M} \sum F ( x , y , t ) . \\ \begin{matrix} ( x , y ) — coordinates of characteristic pixels \\ of macroblocks .\end{matrix}\end{matrix} \qquad ( 6 )$$

Then the absolute values of differences are found:

X(x,y)=|F(x,y,t)−Fcp |where (x,y) are the coordinates of characteristic pixels of macroblock. The control sum of equation (2) is calculated consecutively over coordinates (x,y) in decreasing order of the values.

When the current probe vector is not the actual motion vector for which the control sum is minimal, the calculated control sum increases statistically fast. In this case, calculation with all characteristic pixels is not required. The calculation of control sum is terminated when its value exceeds the best value found already for the probe vectors considered. On average for the frame the speed of motion vector calculation increases additionally by a factor of 1.5-2.

The calculation of the control sum is terminated when its value exceeds the best K-th value found already for the probe vectors considered. On average for the frame the speed of motion vector calculation increases additionally by a factor of 1.5.

The efficiency of the proposed method of motion vector search based on the down sampling technique is illustrated in FIGS. 19 and 20. FIG. 19 shows the motion vectors calculated in the method based on with K=3. FIG. 20 shows the result of MPEG-2 coding of the test sequence with the use of the methods based upon down sampling and then using characteristic pixels with the third embodiment described.

It follows from FIG. 20 that the proposed method under the value Z=2 is inferior to the standard full search method (1) by less than only 1% even already for K=2 and K=3, and is superior to the above considered method which does not use the spatial sub-sampling (FIG. 19). The acceleration factor of the method in comparison with full search method equals 64 for Z=2.

In the method based on down sampling, the use of filtering improves the result. For instance, if the down-sampling was carried out without the filtering according to the formula

F^{(d)}(x,y)=F(2x,2y), (7)

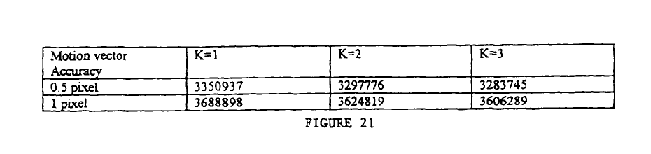

the result would be worse in terms of the compression ratio by 1-2% as shown in FIG. 21 which shows the results without filtering.

Returning now to FIG. (1a), the device operates as follows:

Assume that an analog image signal, i.e. a full coloured TV signal such as a standard SECAM, PAL or NTSC signal is passed to the input 1 of the device. From the input the signal is passed in parallel to the synchronization block 2, in which the corresponding signals are calculated and synchronization impulses are formed, and to analog-to-digital converter 3 in which the discrete samples of the signal are transformed into the digital code, which is passed to the luminance calculator 4. In 4, the luminance calculator, the colour sub-carrier from the full color TV signal is eliminated. The calculation of the luminance signal is necessary as motion estimation is carried out only by reference to the luminance component in the MPEG standard. The synchronization of the luminance calculator 4 is supported by impulses transmitted from the synchronization block 2.

The digital luminance signal is passed from the luminance calculator 4 consecutively to memory block 5 which stores the current frame and memory block 6 which stores the reference frame. In these blocks the discrete samples of the luminance in the current frame are stored. For this frame the motion vectors are calculated with respect to the reference frame.

The outputs of block 5 are connected to the inputs of memory 7 which stores the macroblock for which motion vector is estimated. The macroblock is 16×16 pixels in size. In this block the relief of the macroblock is stored. After calculation of the motion vectors for the first macroblock in the top-left part of the image, the relief of the next macroblock is introduced into the memory. The counting of macroblocks is usually from left to right and from top to bottom.

In block 9 the characteristic pixel levels and their coordinates x and y are calculated in accordance with one of the three embodiments described. In this block the characteristic pixels are also re-ordered in decreasing order of deviation of pixel value from the mean value among characteristic pixels.

The luminance signal levels are stored in memory block 10 in the sequence calculated above, while their (x,y) coordinates are passed through adder 11 to the input of the controller of reference frame memory 6. This memory provides storage in memory block 12 of the levels of pixels with coordinates

(x−V_{0X}−Vₓ, y−V_{0Y}−V_{Y})

where (V_{0X}, V_{0Y}) are the coordinates of the initial shift vector, which can be determined from the results of motion estimation of the corresponding macroblocks in previous frame or from other methods, or set to zero; (Vₓ, V_{Y}) are the coordinates of the current motion vector of the macroblock, which determine the calculation of the control sum.

The values of the corresponding pixels are introduced from memories 10 and 12 in the order discussed above to the pixel subtraction block 13 and from its output to the absolute values adder 14. Blocks 13 and 14 together perform the operation determined by equation (2).

The control sum calculated consecutively in block 14 is introduced in parallel to the sum comparator block 15 and block 16, in which the minimum sum and corresponding motion vectors are calculated. Initially the value of this sum has an unrealistically high value.

After calculation of the control for the initial probe vector the sum is stored in block 16. The value of the sum is compared in following calculations with corresponding sums. After the sum for the initial vector (Vₓ, V_{Y}) is calculated, the comparator block gives the command to shift counter 17 to change the coordinates of the vector, and also sets the sum to zero in adder 14.

The vector (−V_{0X}−V_{X}, −V_{0Y}−V_{Y}) is calculated in counter 17 and then added to the current coordinates of the characteristic pixels of macroblock in counter 17. The coordinates obtained determine the values of pixel levels being passed from block 6 to block 12. The process of motion vector analysis is continued in this manner until the best motion vector is found.

Acceleration of the motion vector analysis by performing control sum calculation in decreasing order of the absoluted deviation of the value at every characteristic pixel from the mean of all characteristic pixels is determined in block 15. If the current control sum at a time prior to the summation process for all characteristic pixels exceeds a previously determined minimal control sum the process of summation is terminated, and the counter 17 changes the current coordinates of motion vector to next values.

The motion vectors calculated in block 16 are stored in memory 18. From memory 18 the coordinates of the vectors are passed to the digital output 19 of the device.

The operation of the various blocks of the device in the sequence described above is controlled 20 by the controller synchronized by the impulses arriving from the output of the synchronization block.

The operation of the device for realization of the proposed method based upon down sampling (FIG. 1-b) consists from the operation of blocks 102-104 which provide the sampling of analog signal, the operation of controller 20, the operation of down-sampling block 105, the operation of the reduced resolution motion vector calculator (blocks 106-119) and the operation of motion vector final resolution calculator (blocks 121-132). The operation of the reduced resolution motion vectors calculator is as described above with respect to FIG. 1a. The difference from the device shown in FIG. 1-a is that blocks 116-119 work with a reduced frame resolution. Thus the macroblocks are 8×8 pixels rather than 16×16 pixels. In addition, the result of the operation of the reduced resolution motion vector calculator is several best motion vectors which are passed to the input of the final resolution motion vector calculator. To calculate several best motion vectors several best control sums and corresponding motion vectors are stored in block 117. In adder 125 the values of motion vectors are increased by the factor of the ratio of the original and down-sampled resolutions (2 in the example as described) and are added to the coordinates of the shift in the reference frame with the use of shift counter 127. The operation of the final resolution motion vectors calculator (blocks 121-132) is also similar to the operation of blocks 115-118 in FIG. 1-a, except that the re-ordering block and the characteristic pixel coordinates calculator are omitted. In addition, when specifying the motion vectors, all pixels of every macroblock are used.

It will be appreciated that the embodiments described enable the speed of motion vector search to be increased very significantly with only a minimal increase in the MPEG data rate.

Various modifications and developments to the embodiments described are possible without departing from the scope of the invention which is defined by the following claims:

1. A method for determining motion vectors representing movement between frames in a sequence of video images, comprising:
storing the pixel values of a current frame and a reference frame;
dividing the current frame into a set of macroblocks;
for each current frame macroblock, selecting from the pixels of the macroblock a plurality of pixels characteristic of the relief of all the pixels of the macroblock; and
searching for a motion vector for the macroblock with respect to the reference frame by minimising a macroblock control sum for a set of motion vectors considered, the control sum being equal to the sum of the norm of the difference between the selected characteristic pixels in the current frame macroblock and the reference frame, wherein the coordinates of the selected characteristic pixels are calculated using all pixel values in the macroblock.

2. A method according to claim 1, comprising digitising an analog input image prior to storage of the pixel values.

3. A method according to claim 1 or 2, comprising down-sampling the pixels of the current and reference frames prior to storage of the current and reference frame values, determining one or more best motion vectors for each macroblock, each macroblock having a reduced number of pixels, the one or more best motion vectors being determined with respect to the down-sampled reference frame by minimising the control sum using the characteristic pixels for the macroblock, increasing the value of the one or more (K) motion vectors by the ratio of the original resolution prior to down sampling to the resolution after down sampling; and in the region of the one or more motion vectors obtained, searching the macroblock motion vector by minimising the control sum using the pixels of the macroblock at original resolution, prior to down sampling.

4. A method according to claim 3, wherein the down sampling comprises spatial sampling.

5. A method according to claim 4, wherein the spatial sampling comprises horizontal and/or vertical sampling.

6. A method according to claim 3, 4 or 5, wherein the down sampling is accompanied by filtering.

7. A method according to any of claims 3 to 6, wherein the macroblock motion vector is searched with whole pixel accuracy.

8. A method according to any of claims 3 to 6, wherein the macroblock is searched with half pixel accuracy.

9. A method according to any preceding claim wherein the selection of characteristic pixels comprises re-ordering pixels in each row of a macroblock in order of value; selecting a number of pixels at points along the row of re-ordered values; re-ordering columns of selected pixels in order of value; selecting the characteristic pixel for the macroblock from points spaced along the re-ordered columns, and storing the coordinates in the original macroblock of the selected characteristic pixels.

10. A method according to claim 9, wherein the pixels selected from the re-ordered rows are substantially evenly distributed along the rows.

11. A method according to claim 10, wherein the selected pixels include the first and last pixel in the row.

12. A method according to claim 9, 10 or 11, wherein the pixels selected from the re-ordered columns are substantially evenly distributed along the columns.

13. A method according to claim 12, wherein the selected pixels include the first and last pixel in the column.

14. A method according to any of claims 1 to 8, wherein the selection of characteristic pixels comprises selecting a number of pixels in the order of decreasing deviation of the absolute values of the pixels from the average value of pixels in the row; arranging the selected pixels into columns and selecting a number of pixels from the columns in the order of decreasing deviation of the absolute values of the pixels from the average value in the column; and storing the coordinates in the original macroblock of every selected pixel.

15. A method according to any of claims 1 to 8, wherein the selection of characteristic pixels comprises dividing macroblocks into a plurality of sub-blocks; selecting the maximum or minimum value pixel from each sub-block such that in the sub-blocks adjacent any given sub-block for which one of the maximum or minimum is selected, the other of the maximum or minimum is selected as the characteristic pixel; and storing the coordinates in the original macroblock of the selected pixels of each sub-block.

16. A method according to any of claims 1 to 8, wherein the consideration of each possible value of motion vector for each macroblock in the minimum control sum determination using the characteristic pixels is carried out in decreasing order of the absolute deviation of the value of the signal at each characteristic pixel from the man value for the set of all characteristic pixels in the macroblock, and wherein the calculation of the minimum sum is terminated if its value exceeds the Kth minimum value of the control sum already determined from motion vectors considered.

17. Apparatus for determining motion vectors representing movement between frames in a sequence of video images, comprising:
a storage means for storing pixel vales of a current frame and a reference frame;
means for dividing the current frame into a set of macroblocks;
selection means for selecting, for each current frame macroblock, from the pixels of the macroblock a plurality of pixels characteristic of the relief of all the pixels of the macroblock;
search means for searching for a motion vector for the macroblock with respect to the reference frame by minimising a macroblock control sum for a set of motion vectors considered, the control sum being equal to the sum of the norm of the difference between selected characteristic pixels; and
means for calculating the coordinates of selected characteristic pixels using all pixel value in the macroblock.

18. Apparatus according to claim 17, comprising an analog-to-digital convertor for converting an input analog signal into a digital signal prior to storage.

19. Apparatus according to claim 17 or 18 comprising:
a down-sampler for down sampling the pixels of the current and reference frames prior to storage of the current and reference frame pixel values in said storage means;
means for determining one or more best motion vectors for each macroblock, each macroblock having a reduced number of pixels following down sampling by the down sampler, the motion vector determining means determining the one or more best motion vector with respect to the down-sampled reference frame using the characteristic pixels from the macroblock;
means for increasing the value of the one or more (K) best motion vectors including a multiplier for multiplying the motion vector by the ratio of the original resolution prior to down sampling to the resolution after down sampling; and
means for searching the macroblock motion vector in the region of the one or more motion vectors obtained by minimising the control sum using the pixels of the macroblock at original resolution prier to down sampling.

20. Apparatus according to claim 19, wherein the down sampler comprises a spatial sampler.

21. Apparatus according to claim 20, wherein the spatial sampler comprises a horizontal sampler and/or a vertical sampler.

22. Apparatus according to claim 19, 20 or 21, wherein the down sampler includes a filter.

23. Apparatus according to any of claims 19 to 22, wherein the search means comprises means for searching the macroblock motion vectors to whole pixel accuracy.

24. Apparatus according to any of claims 19 to 22, wherein the search means comprises means for searching the macroblock motion vectors to half pixel accuracy.

25. Apparatus according to any of claims 17 to 24, wherein the selection means comprises:
means for re-ordering pixels in each row of a macroblock in order of value;
means for selecting a number of pixels at points spaced along the rows of re-ordered values;
means for re-ordering columns of selected pixels in order of increasing value;
means for selecting the characteristic pixel for the macroblock from points spaced along the re-ordered columns; and
a store for storing the coordinates in the original macroblock of the selected characteristic pixels.

26. Apparatus according to claim 25, wherein the means for selecting pixels along the rows of re-ordered pixels selects pixels at point substantially evenly distributed along the rows.

27. Apparatus according to claim 26, wherein the means for selecting pixels along the rows selects pixels including the first and last pixel in each row.

28. Apparatus according to claim 25, 26, or 27 wherein the means for selecting pixels along the columns of re-ordered pixels selects pixels at points substantially evenly distributed along the columns.

29. Apparatus according to claim 28, wherein the means for selecting pixels along the columns selects pixels including the first and last pixel in each column.

30. Apparatus according to any of claims 17 to 24, wherein the means for selecting characteristic pixels comprises;
means for selecting a number of pixels in the order of decreasing deviation of the absolute values of the pixels from the average value of pixels in the row;
means for arranging the pixels into columns in the order of decreasing deviation of the absolute values of the pixels from the average value in the column; and
a store for storing the coordinate in the original macroblock of every selected pixel.

31. Apparatus according to any of claims 17 to 24, wherein the means for selecting characteristic pixels comprises:
a divider for dividing each macroblock into a plurality of sub-blocks;
a selector for selecting the maximum or minimum value pixel in each sub-block such that the selector selects in the sub-blocks adjacent a given sub-block for which a maximum or minimum is selected the other of the maximum or minimum value as the characteristic pixel; and
a store for storing the coordinates in the original macroblock of the selected pixels of each sub-block.

32. Apparatus according to any of claims 17 to 24, wherein the means for search motion vector for a macroblock comprises means for considering each possible motion vector in decreasing order of the absolute deviation of the value of the signal at each characteristic pixel from the mean value for the set of all characteristic pixels in the macroblock; and comprising means for terminating calculation of the minimum sum of its value exceeds the Kth minimum value of the control sum already determined from motion vectors considered.

33. A video coder including apparatus according to any of claims 17 to 32.

34. A computer program comprising code means for performing all the steps of any of claims 1 to 16 when the program is run on a computer.

35. A computer program product comprising program code means stored on a computer readable medium for performing the method of any one of claims 1 to 16 when the program product is run on a computer.
